(19) United States
(12) Patent Application Publication
(10) Pub. No.: US 2026/0203737 A1
(43) Pub. Date: Jul. 16, 2026

(54) SYSTEM AND METHOD FOR CUSTOMIZING VEHICLE AND DIGITAL ASSET MANAGEMENT SYSTEM

(71) Applicant: Honda Motor Co., Ltd., Tokyo (JP)

(72) Inventors: Derrick Ian Cobb, Delaware, OH (US); Robert Lescaille, III, Foothill Ranch, CA (US); Andrew J. Wendling, Columbus, OH (US)

(21) Appl. No.: 19/020,603

(22) Filed: Jan. 14, 2025

(51) Int. Cl. G06Q 20/12; B60K 35/90; G06F 21/10

(52) U.S. Cl. CPC G06Q 20/1235; B60K 35/90; G06F 21/1011; B60K 2360/164; G06Q 2220/10

(57) ABSTRACT

A system for customizing a vehicle having a unique identifier includes a processor in communication with an output device associated with the vehicle and a memory storing instructions. The instructions, when executed by the processor, cause the processor to: receive, via a terminal device associated with the vehicle, a unique code associated with a digital asset; provide, via the terminal device, the unique code to a digital asset management system storing the digital asset; obtain the digital asset from the digital asset management system; link the digital asset to a vehicle digital wallet associated with the unique identifier of the vehicle if the digital asset not linked to the vehicle digital wallet; determine a compatible output device from the output device that is compatible with the digital asset; and change output characteristics of the compatible output device based on the digital asset.

### BACKGROUND

The disclosed subject matter relates to a system and a method for customizing a vehicle. The disclosed subject matter further relates to a digital asset management system.

Vehicles such as cars, vans, trucks, motorcycles, and the like typically include output devices having visual, audible, and/or tactile output characteristics. Examples of such output devices may include an infotainment device, a speedometer display, a heads-up display, lighting, and so forth. Customers may wish to customize the output characteristics of such output devices according to their preferences. For example, one customer may prefer a speedometer display to look futuristic, while another customer may prefer the speedometer display to have a classic analog look.

### SUMMARY

In accordance with one embodiment of the present disclosure, a system for customizing a vehicle having a unique identifier is disclosed. The system includes a processor in communication with at least one output device associated with the vehicle. The at least one output device has one or more output characteristics. The system further includes a memory storing instructions that, when executed by the processor, cause the processor to receive, via a terminal device associated with the vehicle, a unique code associated with a digital asset. The instructions further cause the processor to provide, via the terminal device, the unique code to a digital asset management system storing the digital asset. The instructions further cause the processor to obtain the digital asset from the digital asset management system. The instructions further cause the processor to link the digital asset to a vehicle digital wallet associated with the unique identifier of the vehicle if the digital asset is not linked to the vehicle digital wallet. The instructions further cause the processor to determine at least one compatible output device from the at least one output device that is compatible with the digital asset. The instructions further cause the processor to change the one or more output characteristics of the at least one compatible output device based on the digital asset.

In accordance with another embodiment of the present disclosure, a method for customizing a vehicle having a unique identifier is disclosed. The method includes receiving, via a terminal device associated with the vehicle, a unique code associated with a digital asset. The method further includes providing, via the terminal device, the unique code to a digital asset management system storing the digital asset. The method further includes obtaining the digital asset from the digital asset management system. The method further includes linking the digital asset to a vehicle digital wallet associated with the unique identifier of the vehicle if the digital asset is not linked to the vehicle digital wallet. The method further includes determining at least one output device associated with the vehicle. The at least one output device has one or more output characteristics. The method further includes determining at least one compatible output device from the at least one output device that is compatible with the digital asset. The method further includes changing the one or more output characteristics of the at least one compatible output device based on the digital asset.

In accordance with yet another embodiment of the present disclosure, a digital asset management system is disclosed. The digital asset management system includes a processor. The digital asset management system further includes a memory storing instructions that, when executed by the processor, cause the processor to generate a first unique code associated with a digital asset upon purchase of the digital asset. The instructions further cause the processor to receive a first code from a terminal device associated with a vehicle. The instructions further cause the processor to compare the first code with the first unique code. The instructions further cause the processor to permit access to the digital asset if the first code matches with the first unique code. The instructions further cause the processor to determine a unique identifier of the vehicle based on a vehicle digital wallet linked with the digital asset upon permitting access to the digital asset. The instructions further cause the processor to generate a second unique code associated with the digital asset subsequent to determining the unique identifier. The instructions further cause the processor to encrypt the second unique code with the unique identifier to generate an encrypted code.

### BRIEF DESCRIPTION OF THE DRAWINGS

Certain embodiments of the present disclosure will be better understood from the following description taken in conjunction with the accompanying drawings in which:

FIG. 1 is a block diagram showing a system for customizing a vehicle and a digital management system in accordance with an embodiment of the present disclosure;

FIG. 2 is a perspective view showing a portion of an interior of a vehicle in accordance with an embodiment of the present disclosure;

FIG. 3 is a block diagram of the digital management system in accordance with an embodiment of the present disclosure;

FIG. 4 is another block diagram of the digital management system in accordance with an embodiment of the present disclosure; and

FIG. 5 is a flowchart depicting various steps of a method for customizing a vehicle in accordance with an embodiment of the present disclosure.

### DETAILED DESCRIPTION OF EXEMPLARY EMBODIMENTS

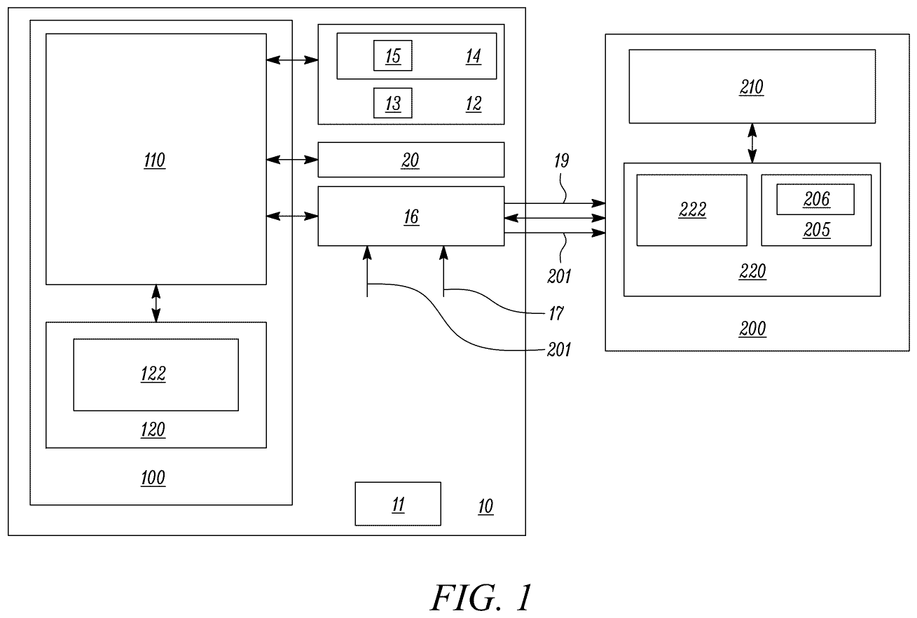

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-5, wherein like numbers indicate the same or corresponding elements throughout the views.

The following includes definitions of selected terms employed herein. The definitions include various examples and/or forms of components that fall within the scope of a term and that can be used for implementation. The examples are not intended to be limiting.

As used herein, “a,” “an,” “the,” “at least one,” and “one or more” are used interchangeably.

As used herein, the term “configured to” is at least as restrictive as the term “adapted to”and requires actual design intention to perform the specified function rather than mere physical capability of performing such a function.

As used herein, “at least one of A and B” should be understood to mean “only A, only B, or both A and B.”

As used herein, the term “vehicle” refers to any moving vehicle that is capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle may include one or more engines. Further, the term “vehicle” also refers to an electric vehicle (EV) that is capable of carrying one or more human occupants and is powered entirely or partially by one or more electric motors powered by an electric battery. The EV may include battery electric vehicles (BEV) and plug-in hybrid electric vehicles (PHEV). The term “vehicle” also refers to an autonomous vehicle and/or self-driving vehicle powered by any form of energy. The autonomous vehicle may or may not carry one or more human occupants. Further, the term “vehicle” refers to vehicles that are automated or non-automated with pre-determined paths or free-moving vehicles.

As used herein, the term “processor” refers generally to any processor that processes signals and performs general computing and arithmetic functions. Signals processed by the processor can include digital signals, data signals, computer instructions, processor instructions, messages, a bit, a bit stream, or other means that can be received, transmitted, and/or detected. Generally, the processor can be a variety of different processor architectures. The term “processor” is intended to encompass central processing units, microprocessors, microcontrollers, reduced instruction set circuits (RISC), application specific integrated circuits (ASIC), logic circuits, and any other circuit or processor capable of executing the functions described herein.

As used herein, the term “memory” refers to volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory may store instructions that are executable by a processor, an operating system, and other data or information.

As used herein, the term “output device” generally refers to any device that outputs information or content. An output device may communicate with and/or be part of another device (e.g., an infotainment device). Some examples of output devices include, but are not limited to, screen displays, heads-up displays, projectors, audio speakers (or other sound or noise-producing devices, such as horns), lights (e.g., ambience lighting, headlights, taillights, fog lamps, etc.), vibration or haptic devices (e.g., vehicle seat massage systems, vehicle suspensions), olfactory devices (e.g., fragrance dispensers), etc.

Referring now to the figures, FIG. 1 illustrates a block diagram of a system 100 in accordance with an embodiment of the present disclosure. FIG. 1 further illustrates a block diagram of a digital asset management system 200 in accordance with an embodiment of the present disclosure.

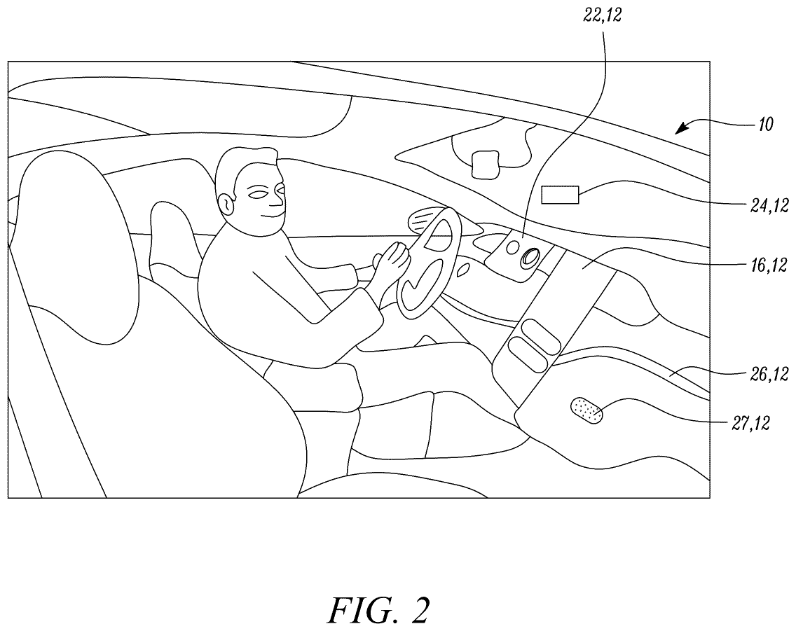

The system 100 is for customizing a vehicle 10. A perspective view of a portion of an interior of the vehicle 10 is shown in FIG. 2. The vehicle 10 has a unique identifier 11. The unique identifier 11 may be uniquely associated with the vehicle 10. That is, the unique identifier 11 may be any identifier that uniquely identifies the vehicle 10 from other vehicles. The unique identifier 11 may include, for example, a string of characters including alphabets, numbers, symbols, and so forth. In some examples, the unique identifier 11 may be a vehicle identification number (VIN) of the vehicle 10.

The system 100 includes a processor 110. The processor 110 may be connected to vehicle systems, sub-systems, hardware components, as well as software applications, and systems that are integrated into the vehicle 10. The processor 110 may have access to the unique identifier 11 of the vehicle 10.

The processor 110 is in communication with at least one output device 12 associated with the vehicle 10. The at least one output device 12 may include any output device that is disposed on the vehicle 10 and is in communication with the processor 110. The at least one output device 12 may be an interior output device (e.g., located in an interior cabin of the vehicle 10) or an exterior output device (e.g., located outside the interior cabin of the vehicle 10). The at least one output device 12 may include a visual output device, an auditory output device, a haptic output device, an olfactory output device, and so forth. In some examples, the at least one output device 12 may include a plurality of output devices 12.

The at least one output device 12 has one or more output characteristics 13. The one or more output characteristics 13 of the at least one output device 12 may be changeable. The one or more output characteristics 13 of the at least one output device 12 may include visual characteristics, auditory characteristics, haptic characteristics, olfactory characteristics, or combinations thereof.

The system 100 further includes a memory 120. The memory 120 is in communication with the processor 110. The memory 120 stores instructions 122 that, when read or executed by the processor 110, may cause the processor 110 to carry out a series of steps.

The instructions 122, when executed by the processor 110, cause the processor 110 to receive, via a terminal device 16 associated with the vehicle 10, a unique code 201 associated with a digital asset 205.

The digital asset 205 may include any form of content that can be provided into a digital form, such as images, audio, video, software, and so forth. The digital asset 205 may be fungible, semi-fungible, or non-fungible. The digital asset 205 may be fungible if it is functionally and/or physically indistinguishable from another digital asset. The digital asset 205 may be non-fungible if it is unique, or one-of-a-kind. The digital asset 205 may be semi-fungible if there is a set of a limited number of similar but distinguishable digital assets. The digital asset 205 may be stored on the digital asset management system 200.

The unique code 201 may be uniquely associated with the digital asset 205. The digital asset 205 may be accessed and obtained from the digital asset management system 200 by providing the unique code 201 to the digital asset management system 200. In some examples, the unique code 201 may be a one-time token that expires after a predetermined time period subsequent to generation thereof. For example, the unique code 201 may be generated upon purchase of the digital asset 205 and may expire after the predetermined time period (e.g., twenty-four hours) subsequent to its generation. In some other examples, the unique code 201 may be a non-fungible token. In such examples, the digital asset 205 may be non-fungible.

The terminal device 16 is also shown in FIG. 2. The vehicle 10 may include the terminal device 16. The terminal device 16 may be coupled to various vehicle systems, sub-systems, hardware components, as well as software applications, and systems that are integrated into the vehicle 10. The terminal device 16 may provide a user with suitable input means for inputting the unique code 201. For example, the terminal device 16 may include a touch screen input for inputting the unique code 201. The terminal device 16 may function both as an input device and an output device. In some examples, the at least one output device 12 may include the terminal device 16. The terminal device 16 may be capable of wireless communication with the digital asset management system 200. In some examples, the terminal device 16 may include an infotainment device located inside the vehicle 10. In some examples, the terminal device 16 may include the processor 110 and/or the memory 120 of the system 100.

The vehicle 10 may further include the at least one output device 12. The vehicle 10 may further include the system 100. FIG. 2 also shows some examples of the at least one output device 12. The at least one output device 12 may include a speedometer display 22 which displays at least a portion of a speedometer and/or an odometer of the vehicle 10. The at least one output device 12 may further include a heads-up display 24 (schematically depicted by a block in FIG. 2) of the vehicle 10. The at least one output device 12 may further include one or more lights 26 (e.g., ambience lights or other lights) of the vehicle 10. The at least one output device 12 may further include one or more speakers 27 of the vehicle 10. In some examples, the vehicle 10 may further include the system 100.

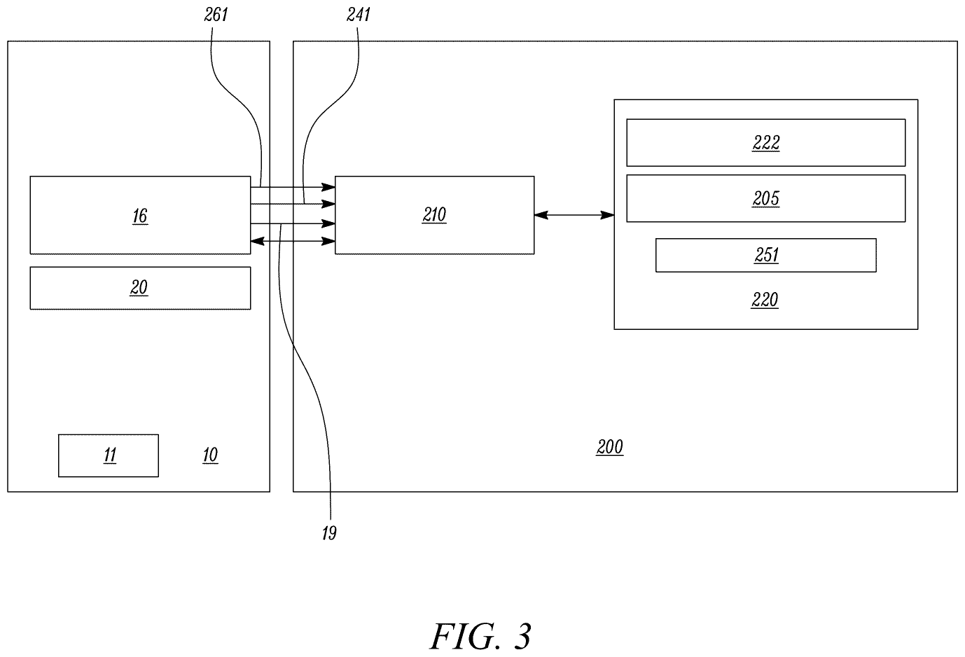

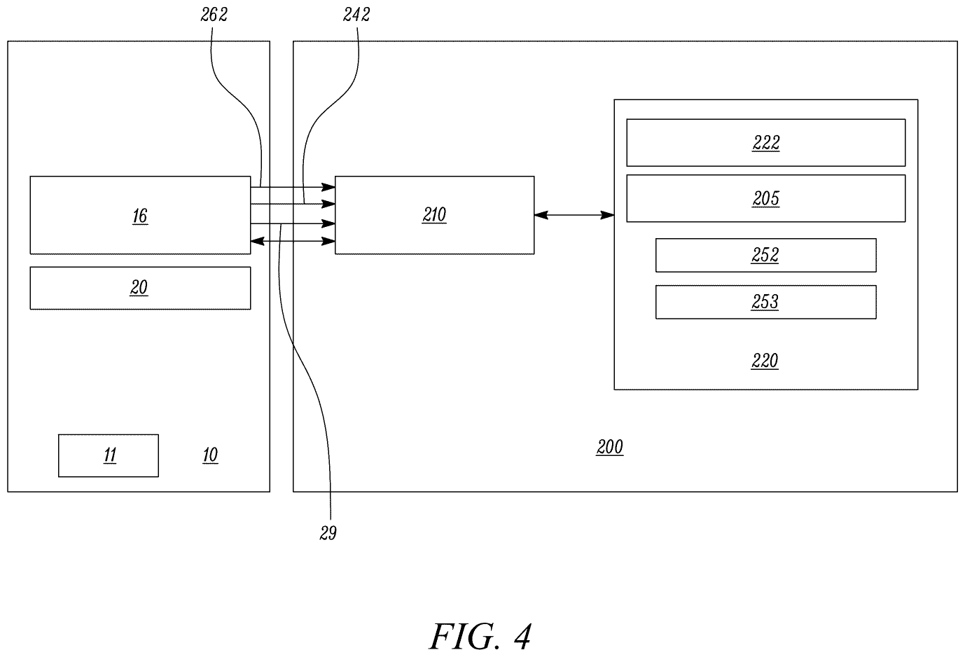

Referring again to FIG. 1, the instructions 122 further cause the processor 110 to provide, via the terminal device 16, the unique code 201 to the digital asset management system 200 storing the digital asset 205. The digital asset management system 200 includes a processor 210 and a memory 220. The digital asset 205 may be stored in the memory 220 of the digital asset management system 200. The processor 210 of the digital asset management system 200 may permit or restrict access to the digital asset 205 based on a code received via the terminal device 16. The digital asset management system 200 will be discussed in greater detail later with reference to FIGS. 3 and 4.

The instructions 122 further cause the processor 110 to obtain the digital asset 205 from the digital asset management system 200. The processor 110 may retrieve (e.g., download) asset data associated with the digital asset 205 from the digital asset management system 200 and perform one or more processing operations (e.g., extract, install, etc.) on the asset data. In some examples, obtaining the digital asset 205 from the digital asset management system 200 may include downloading the digital asset 205 from the digital asset management system 200 and installing the digital asset 205 to the terminal device 16. The digital asset 205 may be accessible via the terminal device 16 upon installation of the digital asset 205 to the terminal device 16.

The instructions 122 further cause the processor 110 to link the digital asset 205 to a vehicle digital wallet 20 associated with the unique identifier 11 of the vehicle 10 if the digital asset 205 is not linked to the vehicle digital wallet 20. The digital asset 205 may not be linked to the vehicle digital wallet 20, for example, when the digital asset 205 is first purchased and obtained.

The digital asset 205 being linked to the vehicle digital wallet 20 may indicate ownership of the digital asset 205 and/or other rights to the digital asset 205. For example, the digital asset 205 that is linked to the vehicle digital wallet 20 may be re-obtained from the digital asset management system 200 via the terminal device 16 associated with the vehicle 10 without needing to repurchase the digital asset 205. The vehicle digital wallet 20 may be stored in the memory 120 of the system 100 or in a secure cloud-based storage (e.g., on the digital asset management system 200). It may be noted that the vehicle digital wallet 20 is separate or disassociated from a user digital wallet (i.e., a digital wallet associated with a user) since the vehicle digital wallet 20 is associated with the unique identifier 11 of the vehicle 10.

In some examples, linking the digital asset 205 to the vehicle digital wallet 20 may include providing, via the terminal device 16, a linking request 19 to the digital asset management system 200. The linking request 19 may instruct the digital asset management system 200 to link the digital asset 205 to the vehicle digital wallet 20.

The instructions 122 further cause the processor 110 to determine at least one compatible output device 14 from the at least one output device 12 that is compatible with the digital asset 205. The at least one compatible output device 14 may have one or more output characteristics 15. In some examples, determining the at least one compatible output device 14 may include determining the one or more output characteristics 13 of each of the at least one output device 12. Determining the at least one compatible output device 14 may further include determining one or more asset-based output characteristics 206 provided by the digital asset 205. Determining the at least one compatible output device 14 may further include comparing the one or more output characteristics 13 of each of the at least one output device 12 with the one or more asset-based output characteristics 206. For example, the one or more asset-based output characteristics 206 may include a voice for a voice assistant of the vehicle 10 as well as a visual theme. Accordingly, the processor 110 may determine speakers and various displays and lights of the vehicle 10 as the at least one compatible output device 14.

The instructions 122 further cause the processor 110 to change the one or more output characteristics 15 of the at least one compatible output device 14 based on the digital asset 205. In other words, the processor 110 may modify or alter the one or more output characteristics 15 of the at least one compatible output device 14 based on the digital asset 205. For example, the processor 110 may change a theme of the terminal device 16 and/or sounds emitted by the one or more speakers 27 corresponding to interactions with the terminal device 16 based on the digital asset 205. In such examples, the graphical user interface (GUI) output by the terminal device 16 may be themed based on the digital asset 205.

In some examples, changing the one or more output characteristics 15 of the at least one compatible output device 14 based on the digital asset 205 may include receiving, via the terminal device 16, a request 17 to change the one or more output characteristics 15 of the at least one compatible output device 14. Changing the one or more output characteristics 15 of the at least one compatible output device 14 may further include changing the one or more output characteristics 15 of the at least one compatible output device 14 to the one or more asset-based output characteristics 206 based on the request 17. As an example, the one or more asset-based output characteristics 206 of the digital asset 205 may include a theme for the terminal device 16 and sounds corresponding to interactions with the terminal device 16. The terminal device 16 may display a list of the one or more asset-based output characteristics 206 (i.e., the theme and the sounds in this example). One, some, or all of the one or more asset-based output characteristics 206 may be selectable from the list and provided as the request 17. In some examples, the terminal device 16 may be communicably coupled (or paired) with a portable device (e.g., a smartphone). The terminal device 16 may receive the request 17 from the portable device. The portable device may be used to control the one or more output characteristics 15. The terminal device 16 may include means to allow or disallow such control using the portable device.

The system 100 may facilitate customizing the vehicle 10 based on the digital asset 205. The system 100 may allow users to customize the one or more output characteristics 13 of the at least one output device 12 according to their preferences by purchasing corresponding digital assets. The system 100 may also allow users to use licensed skins, sounds, and lighting configurations for customizing the vehicle 10 based on various digital assets. As an example, the user may apply a first digital asset to change a voice of a voice assistant of the vehicle 10, apply a second digital asset to change a look of the speedometer display 22 (shown in FIG. 2) of the vehicle 10, and apply a third digital asset to adjust the lights 26 (shown in FIG. 2) of the vehicle 10 and sounds corresponding to interactions with the terminal device 16 (e.g., an infotainment device) of the vehicle 10. Furthermore, any digital asset obtained using the system 100 may be linked to the vehicle digital wallet 20, and as a result, may be associated with the vehicle 10 instead of the user of the vehicle 10. This may restrict unauthorized sharing of linked digital assets with other vehicles.

FIG. 3 shows a block diagram of the digital asset management system 200 in accordance with an embodiment of the present disclosure. As discussed above, the digital asset management system 200 includes the processor 210 and the memory 220. The memory 220 may store the digital asset 205. In some examples, the digital asset 205 may be stored in a remote server communicably coupled to the processor 210.

The memory 220 further stores instructions 222 that, when executed by the processor 210, cause the processor 210 to generate a first unique code 251 associated with the digital asset 205 upon purchase of the digital asset 205. The first unique code 251 may be a one-time token. That is, the first unique code 251 may be valid for a predetermined time period and may expire subsequent to the predetermined time period.

The instructions 222 may further cause the processor 210 to provide the first unique code 251 to a user to permit a first access 241 to the digital asset 205 subsequent to the purchase of the digital asset 205. For example, the processor 210 may share the first unique code 251 with the user via a text message, an email, and so forth, upon successful purchase of the digital asset 205.

The instructions 222 further cause the processor 210 to receive a first code 261 from the terminal device 16 associated with the vehicle 10. The first code 261 may be inputted to the terminal device 16 by the user.

The instructions 222 further cause the processor 210 to compare the first code 261 with the first unique code 251. Any suitable comparison technique may be employed by the processor 210 to compare the first code 261 with the first unique code 251.

The instructions 222 further cause the processor 210 to permit access to the digital asset 205 if the first code 261 matches with the first unique code 251. In some examples, the processor 210 may allow the terminal device 16 (or the processor 110 of FIG. 1) to obtain the digital asset 205 if the first code 261 matches with the first unique code 251. Thus, the digital asset management system 200 may authenticate the first code 261 before providing access to the digital asset 205.

In some examples, the instructions 222 may further cause the processor 210 to receive the linking request 19 (also shown in FIG. 1) from the terminal device 16 to link the digital asset 205 to the vehicle digital wallet 20. The instructions 222 may further cause the processor 210 to link the digital asset 205 with the vehicle digital wallet 20.

The digital asset management system 200 may facilitate management of a variety of digital assets, such as the digital asset 205. The digital asset management system 200 may allow purchasing, selling, and obtaining digital assets. In other words, the digital asset management system 200 may function as a marketplace for buying and selling digital assets. The digital asset management system 200 may allow transactions between many different parties, for example, transactions between two or more users, and between artists or studios and users. The digital asset management system 200 may also facilitate linking digital assets to the vehicle digital wallet 20.

FIG. 4 illustrates a block diagram of the digital asset management system 200 in accordance with an embodiment of the present disclosure. In some cases, the digital asset 205 may need to be re-obtained. For example, in cases where the terminal device 16 crashes or needs replacement, the digital asset 205 may need to be re-obtained to install the digital asset 205 to the terminal device 16.

The instructions 222 further cause the processor 210 to determine the unique identifier 11 of the vehicle 10 based on the vehicle digital wallet 20 linked with the digital asset 205 upon permitting access to the digital asset 205. The vehicle digital wallet 20 may be associated with the unique identifier 11, such that the processor 210 can determine the unique identifier 11 based on the vehicle digital wallet 20.

The instructions 222 further cause the processor 210 to generate a second unique code 252 associated with the digital asset 205 subsequent to determining the unique identifier 11. The second unique code 252 may be different from the first unique code 251. The second unique code 252 may be a one-time token. That is, the second unique code 252 may be valid for a predetermined time period and may expire subsequent to the predetermined time period. In some examples, each of the first unique code 251 (shown in FIG. 3) and the second unique code 252 may be a one-time token.

The instructions 222 further cause the processor 210 to encrypt the second unique code 252 with the unique identifier 11 to generate an encrypted code 253. The encrypted code 253 may be decrypted using the unique identifier 11 and may correspond to the second unique code 252 upon decryption using the unique identifier 11. The unique code 201 discussed above with reference to FIG. 1 may be the first unique code 251 or the encrypted code 253.

The instructions 222 may further cause the processor 210 to provide the encrypted code 253 to the user to permit a second access 242 to the digital asset 205 subsequent to the first access 241 (shown in FIG. 3). For example, the processor 210 may share the encrypted code 253 with the user via a text message, an email, and so forth, upon receiving a user request 29.

The instructions 222 may further cause the processor 210 to receive a decrypted code 262 from the terminal device 16. The decrypted code 262 may be decrypted using the unique identifier 11. In some examples, the decrypted code 262 may be decrypted by the terminal device 16 (or the processor 110 of FIG. 1) with the unique identifier 11. In some alternate examples, the instructions 222 may cause the processor 210 to receive the encrypted code 253 and the unique identifier 11 from the terminal device 16 and determine the decrypted code 262 by decrypting the encrypted code 253 using the unique identifier 11.

The instructions 222 may further cause the processor 210 to compare the decrypted code 262 with the second unique code 252. Any suitable comparison technique may be employed by the processor 210 to compare the decrypted code 262 with the second unique code 252.

The instructions 222 may further cause the processor 210 to permit access to the digital asset 205 if the decrypted code 262 matches with the second unique code 252. In some examples, the processor 210 may allow the terminal device 16 to obtain the digital asset 205 if the decrypted code 262 matches with the second unique code 252. As a result, the digital asset management system 200 may facilitate re-obtaining the digital asset 205 in case of a failure while enforcing authenticity.

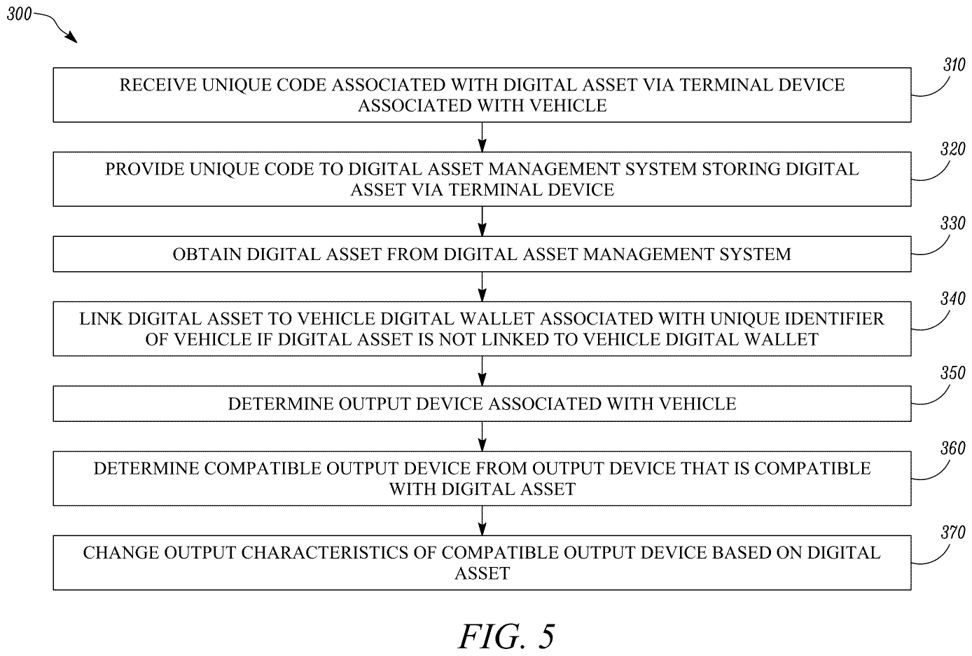

FIG. 5 illustrates a flowchart depicting various steps of a method 300 for customizing a vehicle having a unique identifier (e.g., the vehicle 10 shown in FIG. 1) in accordance with an embodiment of the present disclosure. The method 300 may be carried out, for example, by the system 100 of FIG. 1. The method 300 will be discussed with further reference to FIG. 1.

At step 310, the method 300 includes receiving, via a terminal device associated with the vehicle, a unique code associated with a digital asset. Referring to FIG. 1, for example, the method 300 may include receiving, via the terminal device 16 associated with the vehicle 10, the unique code 201 associated with the digital asset 205.

In some examples, the unique code is a one-time token that expires after a predetermined time period subsequent to generation thereof. Referring to FIG. 1, for example, the unique code 201 may be a one-time token that expires after a predetermined time period subsequent to generation thereof.

In some examples, the unique code is a non-fungible token. Referring to FIG. 1, for example, the unique code 201 may be a non-fungible token.

At step 320, the method 300 further includes providing, via the terminal device, the unique code to a digital asset management system storing the digital asset. Referring to FIG. 1, for example, the method 300 may include providing, via the terminal device 16, the unique code 201 to the digital asset management system 200 storing the digital asset 205.

At step 330, the method 300 further includes obtaining the digital asset from the digital asset management system. Referring to FIG. 1, for example, the method 300 may include obtaining the digital asset 205 from the digital asset management system 200.

In some examples, obtaining the digital asset from the digital asset management system includes downloading the digital asset from the digital asset management system and installing the digital asset to the terminal device. Referring to FIG. 1, for example, obtaining the digital asset 205 from the digital asset management system 200 may include downloading the digital asset 205 from the digital asset management system 200 and installing the digital asset 205 to the terminal device 16.

At step 340, the method 300 further includes linking the digital asset to a vehicle digital wallet associated with the unique identifier of the vehicle if the digital asset is not linked to the vehicle digital wallet. Referring to FIG. 1, for example, the method 300 may include linking the digital asset 205 to the vehicle digital wallet 20 associated with the unique identifier 11 of the vehicle 10 if the digital asset 205 is not linked to the vehicle digital wallet 20.

In some examples, linking the digital asset to the vehicle digital wallet includes providing, via the terminal device, a linking request to the digital asset management system. The linking request instructs the digital asset management system to link the digital asset to the vehicle digital wallet. Referring to FIG. 1, for example, linking the digital asset 205 to the vehicle digital wallet 20 may include providing, via the terminal device 16, the linking request 19 to the digital asset management system 200.

At step 350, the method 300 further includes determining at least one output device associated with the vehicle. The at least one output device has one or more output characteristics. Referring to FIG. 1, for example, the method 300 may include determining the at least one output device 12 associated with the vehicle 10.

At step 360, the method 300 further includes determining at least one compatible output device from the at least one output device that is compatible with the digital asset. Referring to FIG. 1, for example, the method 300 may include determining the at least one compatible output device 14 from the at least one output device 12 that is compatible with the digital asset 205.

In some examples, determining the at least one compatible output device includes determining the one or more output characteristics of each of the at least one output device, determining one or more asset-based output characteristics provided by the digital asset, and comparing the one or more output characteristics of each of the at least one output device with the one or more asset-based output characteristics. Referring to FIG. 1, for example, determining the at least one compatible output device 14 may include determining the one or more output characteristics 13 of each of the at least one output device 12, determining the one or more asset-based output characteristics 206 provided by the digital asset 205, and comparing the one or more output characteristics 13 of each of the at least one output device 12 with the one or more asset-based output characteristics 206.

At step 370, the method 300 further includes changing the one or more output characteristics of the at least one compatible output device based on the digital asset. Referring to FIG. 1, for example, the method 300 may include changing the one or more output characteristics 15 of the at least one compatible output device 14 based on the digital asset 205.

In some examples, changing the one or more output characteristics of the at least one compatible output device based on the digital asset includes receiving, via the terminal device, a request to change the one or more output characteristics of the at least one compatible output device. Changing the one or more output characteristics of the at least one compatible output device based on the digital asset further includes changing the one or more output characteristics of the at least one compatible output device to one or more asset-based output characteristics based on the request. Referring to FIG. 1, for example, changing the one or more output characteristics 15 of the at least one compatible output device 14 based on the digital asset 205 may include receiving, via the terminal device 16, the request 17 to change the one or more output characteristics 15 of the at least one compatible output device 14, and changing the one or more output characteristics 15 of the at least one compatible output device 14 to the one or more asset-based output characteristics 206 based on the request 17.

The method 300 may facilitate customizing the vehicle based on the digital asset. The method 300 may allow users to customize the one or more output characteristics of the at least one output device according to their preferences by purchasing corresponding digital assets. The method 300 may also allow users to use licensed skins, sounds, and lighting configurations for customizing the vehicle based on various digital assets. As an example, the user may apply a first digital asset to change a voice of a voice assistant of the vehicle, apply a second digital asset to change a look of a speedometer display of the vehicle, and apply a third digital asset to adjust lights of the vehicle and sounds corresponding to interactions with the terminal device (e.g., an infotainment device) of the vehicle. Furthermore, any digital asset obtained using the method 300 may be linked to the vehicle digital wallet, and as a result, may be associated with the vehicle instead of the user of the vehicle. This may restrict unauthorized sharing of linked digital assets with other vehicles.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the disclosure be defined by the claims appended hereto.

What is claimed is:

1. A system for customizing a vehicle having a unique identifier, the system comprising:
a processor in communication with at least one output device associated with the vehicle, the at least one output device having one or more output characteristics; and
a memory storing instructions that, when executed by the processor, cause the processor to:
receive, via a terminal device associated with the vehicle, a unique code associated with a digital asset;
provide, via the terminal device, the unique code to a digital asset management system storing the digital asset;
obtain the digital asset from the digital asset management system;
link the digital asset to a vehicle digital wallet associated with the unique identifier of the vehicle if the digital asset is not linked to the vehicle digital wallet;
determine at least one compatible output device from the at least one output device that is compatible with the digital asset; and
change the one or more output characteristics of the at least one compatible output device based on the digital asset.

2. The system of claim 1, wherein obtaining the digital asset from the digital asset management system comprises:
downloading the digital asset from the digital asset management system; and
installing the digital asset to the terminal device.

3. The system of claim 1, wherein linking the digital asset to the vehicle digital wallet comprises providing, via the terminal device, a linking request to the digital asset management system, the linking request instructing the digital asset management system to link the digital asset to the vehicle digital wallet.

4. The system of claim 1, wherein determining the at least one compatible output device comprises:
determining the one or more output characteristics of each of the at least one output device;
determining one or more asset-based output characteristics provided by the digital asset; and
comparing the one or more output characteristics of each of the at least one output device with the one or more asset-based output characteristics.

5. The system of claim 1, wherein changing the one or more output characteristics of the at least one compatible output device based on the digital asset comprises:
receiving, via the terminal device, a request to change the one or more output characteristics of the at least one compatible output device; and
changing the one or more output characteristics of the at least one compatible output device to one or more asset-based output characteristics based on the request.

6. The system of claim 1, wherein the unique code is a one-time token that expires after a predetermined time period subsequent to generation thereof.

7. The system of claim 1, wherein the unique code is a non-fungible token.

8. The system of claim 1, wherein the unique identifier is a vehicle identification number (VIN) of the vehicle.

9. The system of claim 1, wherein the terminal device comprises an infotainment device located inside the vehicle.

10. A method for customizing a vehicle having a unique identifier, the method comprising:
receiving, via a terminal device associated with the vehicle, a unique code associated with a digital asset;
providing, via the terminal device, the unique code to a digital asset management system storing the digital asset;
obtaining the digital asset from the digital asset management system;
linking the digital asset to a vehicle digital wallet associated with the unique identifier of the vehicle if the digital asset not linked to the vehicle digital wallet;
determining at least one output device associated with the vehicle, the at least one output device having one or more output characteristics;
determining at least one compatible output device from the at least one output device that is compatible with the digital asset; and
changing the one or more output characteristics of the at least one compatible output device based on the digital asset.

11. The method of claim 10, wherein obtaining the digital asset from the digital asset management system comprises:
downloading the digital asset from the digital asset management system; and
installing the digital asset to the terminal device.

12. The method of claim 10, wherein linking the digital asset to the vehicle digital wallet comprises providing, via the terminal device, a linking request to the digital asset management system, the linking request instructing the digital asset management system to link the digital asset to the vehicle digital wallet.

13. The method of claim 10, wherein determining the at least one compatible output device comprises:
determining the one or more output characteristics of each of the at least one output device;
determining one or more asset-based output characteristics provided by the digital asset; and
comparing the one or more output characteristics of each of the at least one output device with the one or more asset-based output characteristics.

14. The method of claim 10, wherein changing the one or more output characteristics of the at least one compatible output device based on the digital asset comprises:
receiving, via the terminal device, a request to change the one or more output characteristics of the at least one compatible output device; and
changing the one or more output characteristics of the at least one compatible output device to one or more asset-based output characteristics based on the request.

15. The method of claim 10, wherein the unique code is a one-time token that expires after a predetermined time period subsequent to generation thereof.

16. A digital asset management system comprising:
a processor; and
a memory storing instructions that, when executed by the processor, cause the processor to:
generate a first unique code associated with a digital asset upon purchase of the digital asset;
receive a first code from a terminal device associated with a vehicle;
compare the first code with the first unique code;
permit access to the digital asset if the first code matches with the first unique code;
determine a unique identifier of the vehicle based on a vehicle digital wallet linked with the digital asset upon permitting access to the digital asset;
generate a second unique code associated with the digital asset subsequent to determining the unique identifier; and
encrypt the second unique code with the unique identifier to generate an encrypted code.

17. The digital asset management system of claim 16, wherein the instructions further cause the processor to:
provide the first unique code to a user to permit a first access to the digital asset subsequent to the purchase of the digital asset; and
provide the encrypted code to the user to permit a second access to the digital asset subsequent to the first access.

18. The digital asset management system of claim 16, wherein the instructions further cause the processor to:
receive a decrypted code from the terminal device, wherein the decrypted code is decrypted using the unique identifier;
compare the decrypted code with the second unique code; and
permit access to the digital asset if the decrypted code matches with the second unique code.

19. The digital asset management system of claim 16, wherein each of the first unique code and the second unique code is a one-time token.

20. The digital asset management system of claim 16, wherein the instructions further cause the processor to:
receive a linking request from the terminal device to link the digital asset to the vehicle digital wallet; and
link the digital asset with the vehicle digital wallet.
